(19) United States
(12) Patent Application Publication
(10) Pub. No.: US 2005/0050127 A1
(43) Pub. Date: Mar. 3, 2005

(54) LMS adaptive filter

(76) Inventor: Woo Chan Kim, Gyeonggi-do (KR)

Correspondence Address: BIRCH STEWART KOLASCH & BIRCH, PO BOX 747, FALLS CHURCH, VA, 22040-0747, US

(21) Appl. No.: 10/927,070

(22) Filed: Aug. 27, 2004

(30) Foreign Application Priority Data
Aug. 29, 2003 (KR) P2003-60219

(51) Int. Cl. G06F 17/10

(52) U.S. Cl. 708/322

(57) ABSTRACT

The present invention provides an LMS adaptive filter, by which signal distortion due to time interval is compensated and by which a filter size can be minimized. The present invention includes a first multiplier alternately outputting a value calculated by multiplying a first delayed signal and an error signal together and a value calculated by multiplying a second delayed signal and the error signal together, an adder adding a signal outputted from the first multiplier to a previous coefficient, a first delayer receiving a signal outputted from the adder and outputting a first new coefficient by synchronization with a first clock, a second delayer receiving the signal outputted from the adder and outputting a second new coefficient by synchronization with a reference clock, a second multiplier alternately outputting a value calculated by multiplying the first new coefficient and the input signal and a value calculated by multiplying the second new coefficient and a third delayed signal, and a third delayer outputting a signal outputted from the second multiplier by synchronization with a second clock.

This application claims the benefit of the Korean Application No. P2003-60219 filed on Aug. 29, 2003, which is hereby incorporated by reference.

### BACKGROUND OF THE INVENTION

1. Field of the Invention

The present invention relates to an LMS (least mean square) adaptive filter applicable to an equalizer, noise remover, and the like of a digital TV.

2. Discussion of the Related Art

Generally, a least mean square (hereinafter abbreviated LMS) adaptive filter is a filter keeping updating a coefficient using TMS adaptive algorithm. The LMS adaptive filter is operative in compensating a signal distortion caused by channels or a system itself.

FIG. 1 is a structural diagram of an LMS adaptive filter according to a related art.

Referring to FIG. 1, a first delayer D1 receives an input signal x0 and outputs a delayed signal x1. A second delayer D2 receives the delayed signal x1 and outputs a delayed signal x2. A third delayer D3 receives a delayed signal xd0 and outputs a delayed signal xd1. And, a fourth delayer D4 receives the delayed signal xd1 and outputs a delayed signal xd2.

The delayed signals xd0, xd1, and xd2 are signals delayed from the signals x0, x1, and x2 by prescribed delay times, respectively. And, the delay times are variable according to a circuit design. For instance, ‘x0’ is passed through one delayer D1 to provide ‘xd0’. Yet, ‘x0’ can be passed through at least two delayers D1 and D2 to provide ‘xd0’. Such a procedure is applicable to ‘xd1’ or ‘xd2’ as well.

A first tap unit T1 receiving the signals x0 and xd0 to output an output signal y0 and a second tap unit T2 receiving the signals x1 and xd1 to output an output signal y1 are provided. The first tap unit T1 has the same configuration of the second tap unit T2.

The first tap unit T1 consists of a first multiplier M1 multiplying the delayed signal xd0 by an error ‘e’, a first adder A1 adding an operational result of the first multiplier M1 to a previous coefficient, a fifth delayer D5 synchronized with a unit cycle signal to store an output result of the first adder A1 and to output a new coefficient c0, and a second multiplier M2 producing an output signal y0 for a first tap by multiplying the coefficient c0 outputted from the fifth delayer D5 by the input signal x0.

The second tap unit T2 consists of a third multiplier M3 multiplying the delayed signal xd1 by an error ‘e’, a second adder A2 adding an operational result of the third multiplier M3 to a previous coefficient, a sixth delayer D6 synchronized with a unit cycle signal to store an output result of the second adder A2 and to output a new coefficient c1, and a fourth multiplier M4 producing an output signal y1 for a second tap by multiplying the coefficient c1 outputted from the sixth delayer D6 by the delayed signal x1.

A coefficient update process in the LMS adaptive filter is explained as follows.

First of all, the delayed signal xd0 is multiplied by the error ‘e’ in the first multiplier M1 of the first tap unit T1. A multiplied result is added to the previous coefficient by the first adder A1. A value computed by the first adder A1 is synchronized with the unit cycle signal to be stored in the fifth delayer D5. And, the coefficient c0 is updated with this value.

Simultancously, the delayed signal xd1 is multiplied by the error ‘e’ in the third multiplier M3 of the second tap unit T2. A multiplied result is added to the previous coefficient by the second adder A2. A value computed by the second adder A2 is synchronized with the unit cycle signal to be stored in the sixth delayer D6. And, the coefficient c1 is updated with this value.

Subsequently, the input signal x0 is multiplied by the coefficient c0 in the second multiplier M2 to generate the output signal y0 of the first tap T1. And, the delayed signal x1 is multiplied by the coefficicnt c1 in the fourth multiplier M4 to generate the output signal y1 of the second tap T2.

Thus, each tap of the LMS adaptive filter needs one multiplier and one adder for coefficient update and one multiplier for generating the output signal.

For the smooth broadcast reception via channel having distortion (long-term fading) due to time interval in the recent terrestrial TV, the distortion needs to be compensated. In order to effective compensate the distortion due to the time interval, the filter used in the equalizer or noise-remover should be provided with many taps.

However, the related filter having many taps has difficult in implementation since a size of the filter should be increased to include many taps therein.

### SUMMARY OF THE INVENTION

Accordingly, the present invention is directed to an LMS (least mean square) adaptive filter that substantially obviates one or more problems due to limitations and disadvantages of the related art

An object of the present invention is to provide an LMS adaptive filter, by which signal distortion due to time interval is compensated and by which a filter size can be minimized.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an adaptive filter according to the present invention includes a first multiplier alternately outputting a value found by multiplying a first delayed signal and an error signal together and a value found by multiplying a second delayed signal and the error signal together wherein each of the first and second delayed signals is delayed behind an input signal, an adder adding a signal outputted from the first multiplier to a previous coefficient, a first delayer receiving a signal outputted from the adder to output a first new coefficient by synchronization with a first clock, a second delayer receiving the signal outputted from the adder to output a second new coefficient by synchronization with a reference clock, a second multiplier alternately outputting a value found by multiplying the first new coefficient by the input signal and a value found by multiplying the second new coefficient by a third delayed signal, and a third delayer synchronizing a signal outputted from the second multiplier with a second clock to output.

Preferably, the first clock is delayed by ½ cycle more than the reference clock. And, the second clock is delayed by ¼ cycle more than the reference clock.

In another aspect of the present invention, an adaptive filter includes a first multiplexer outputting either a first delayed input signal delayed behind an input signal or a second delayed signal according to a selection signal, a first multiplier multiplying a signal outputted from the first multiplexer by an error signal, an adder adding a signal outputted from the first multiplier to a previous coefficient, a first delayer receiving a signal outputted from the adder to output a first new coefficient by synchronization with a first clock, a second delayer receiving the signal outputted from the adder to output a second new coefficient by synchronization with a reference clock, a second multiplexer outputting either the first new coefficient outputted from the first delayer or the second new coefficient outputted from the second delayer to the adder according to the selection signal, a third multiplexer outputting either the input signal or a third delayed signal delayed behind the input signal according to the selection signal, a second multiplier multiplying a coefficient outputted from the second multiplexer by a signal outputted from the third multiplexer, and a third delayer synchronizing a signal outputted from the second multiplier with a second clock to output.

Preferably, the first new coefficient includes the first delayed signal, the error signal, and the previous coefficient. And, the second new coefficient includes the second delayed signal, the error signal, and the previous coefficient.

Preferably, the adaptive filter further includes a delayer receiving the first delayed signal to output the second delayed signal delayed behind the first delay signal. And, the delayer synchronizes the second delayed signal with the reference clock to output.

Preferably, the adaptive filter further includes a delayer receiving the input signal to output the third delayed signal delayed behind the input signal. And, the delayer synchronizes the third delayed signal with the reference clock to output.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a structural diagram of an LMS adaptive filter according to a related art;

FIG. 2 is a block diagram of an LMS adaptive filter according to a first embodiment of the present invention;

FIG. 3 is a block diagram of an LMS adaptive filter according to a second embodiment of the present invention; and

FIG. 4 and FIG. 5 are timing diagrams of an LMS adaptive filter according to the present invention.

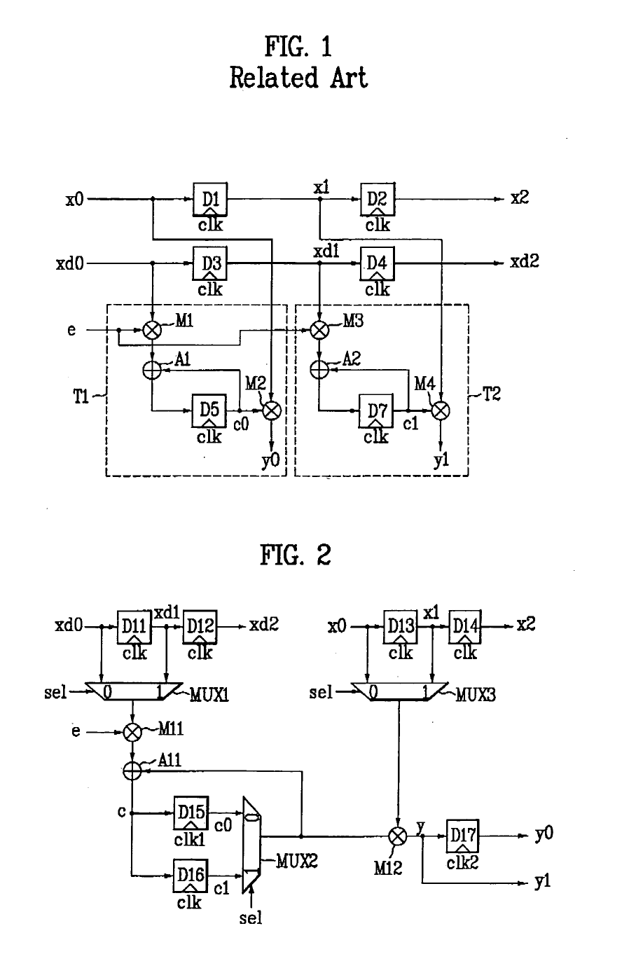

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First Embodiment

FIG. 2 is a block diagram of an LMS adaptive filter according to a first embodiment of the present invention.

Referring to FIG. 2, a first delayer D11 receives a signal xd0 delayed by a prescribed time behind an input signal x0 and outputs a signal xd1 delayed more than the delayed signal xd0. A second delayer D12 receives the delayed signal xd1 and outputs a signal xd2 delayed more than the delayed signal xd1. A third delayer D13 receives the input signal x0 and outputs a signal x1 delayed more than the input signal x0. And, a fourth delayer D14 receives the delayed signal x1 and outputs a signal x2 delayed more than the delayed signal x1. The first to fourth delayers D11 to D14 are synchronized with a reference clock signal elk to output the delayed signals xd1, xd2, x1, and x2, respectively. Each of the delayed signals xd1, xd2, x1, and x2 is delayed more than the input signal x0. Each delay time of the delayed signals xd1, xd2, x1, and x2 can be varies according to a circuit design. The input signal x0 is passed through one delayer to provide the delayed signal xd0. Besides, the input signal x0 may be passed through at least two delayers to provide the delayed signal xd0.

A first multiplexer MUX1 receives the two delayed signals xd0 and xd1 and selectively outputs one of the delayed signals xd0 and xd1 according to a logic value or level of an selection signal sel inputted from outside. For instance, if the selection signal sel indicates a low level, the first multiplexer MUX1 outputs the delayed signal xd0. If the selection signal sel indicates a high level, the first multiplexer MUX1 outputs the delayed signal xd1.

A first multiplier M11 receives the signal outputted from the first multiplexer MUX1 and an error signal ‘c’ and multiplies the two received signals together. An adder A11 adds a signal outputted from the first multiplier M11 to a previous coefficient outputted from a second multiplexer MUX2. A signal (coefficient) ‘c’ outputted from the adder A11 includes the delayed signals xd0 and xd1, the error signal ‘e’, and the previous coefficient.

A fifth delayer D15 stores the signal (coefficient) ‘c’ outputted from the first adder A11 and outputs a signal c0 delayed more than the signal ‘c’. The delayed signal c0 includes the delayed signal xd0, the error signal ‘e’, and the previous coefficient. The fifth delayer D15 outputs the signal c0 by synchronization with a first clock signal clk1. In doing so, a phase of the first clock signal clk1 is exactly opposite to that of the reference clock signal clk. Namely, the first clock signal clk1 is delayed by ½ cycle more than the reference clock cycle clk. Hence, if the reference clock signal clk indicates high level, the first clock signal clk1 becomes low level. If the reference clock signal clk indicates low level, the first clock signal clk1 becomes high level.

A sixth delayer D16 receives the signal ‘c’ outputted from the first adder A11 and outputs a signal c1 delayed more than the received signal ‘c’. The sixth delayer D16 outputs the delayed signal c1 by synchronization with the reference clock signal clk. The delayed signal c1 includes the delayed signal xd1, the error signal ‘e’, and the previous coefficient.

A second multiplexer MUX2 receives the two delayed signals c0 and c1, i.e., a pair of new coefficients, from the fifth and sixth delayers D15 and D16, respectively and then selectively outputs one of the delayed signals c0 and c1 according to a logic value or level of the selection signal sel inputted from outside. For instance, if the selection signal sel indicates a low level, the second multiplexer MUX2 outputs the delayed signal c0. If the selection signal sel indicates a high level, the second multiplexer MUX2 outputs the delayed signal c1.

A third multiplexer MUX3 receives the input signal x0 and the delayed signal x1 and selectively outputs one of the signals x0 and x1 according to a logic value or level of the selection signal sc1 inputted from outside. For instance, if the selection signal sel indicates a low level, the third multiplexer MUX3 outputs the input signal x0. If the selection signal sel indicates a high level, the third multiplexer MUX3 outputs the delayed signal x1.

A second multiplier M12 receives signals outputted from the second and third multiplexers MUX2 and MUX3 and multiplies the two received signals together. A signal ‘y’ outputted from the second multiplier M12 includes the new coefficients c0 and c1, the input signal x0, and the delayed signal x1.

A seventh delayer D17 receives the signal ‘y’ outputted from the second multiplier M12 and outputs a signal y0 delayed more than the signal ‘y’ by synchronization with a second clock signal clk2. The second clock signal clk2 is a clock delayed by ¼ cycle more than the reference clock cycle clk.

A process of updating a coefficient in the LMS adaptive filter according to the present invention is explained as follows.

If a logic value of the selection signal sel, as shown in FIG. 4, inputted to the first multiplexer MUX1 is ‘1’, the first multiplexer MUX1y outputs the delayed signal xd0. The first multiplier M11 multiplies the delayed signal xd0 by the error signal ‘e’ to output ‘e^{×}xd0’. When the selection signal sel is inputted to the first multiplexer MUX1, the selection signal sel is inputted to the second multiplexer MUX2 as well. Hence, the second multiplexer MUX2 outputs the previous coefficient c0. The adder A11 receives ‘e^{×}xd0’ from the first multiplier M11 and the previous coefficient c0 from the second multiplexer MUX2. And, the adder A11 adds ‘e^{×}xd0’ to the previous coefficient c0 to output the coefficient ‘c’. In this case, the coefficient ‘c’ is ‘c0+(e×xd0)’

If the logic value of the selection signal sel inputted to the first multiplexer MUX1 is ‘1’, the first multiplexer MUX1 outputs the delayed signal xd1. The first multiplier M11 then multiplies the delayed signal xd1 by the error signal ‘e’ to output ‘e^{×}xd1’. As the selection signal sel having the logic value ‘1’ is inputted to the second multiplexer MUX2, the second multiplexer MUX2 outputs the previous coefficient c1. The adder A11 receives ‘e^{×}xd1’ from the first multiplier M11 and the previous coefficient c1 from the second multiplexer MUX2. And, the adder A11 adds ‘e^{×}xd1’ to the previous coefficient c1 to output the coefficient ‘c’. In this case, the coefficicnt ‘c’ is ‘c1+(e×xd1)’.

The fifth delayer D15 receives the coefficient ‘c’ outputted from the adder A11 and outputs the new coefficient c0 at a rising edge of the first clock signal clk1. The new coefficient c0 keeps being outputted until a next rising edge of the first clock signal clk1.

The sixth delayer D16 receives the coefficient ‘c’ outputted from the adder A11 and outputs the new coefficient c1 at a rising edge of the reference clock signal clk. The new coefficient c1 keeps being outputted until a next rising edge of the reference clock signal clk.

The second multiplexer MUX2 outputs the new coefficient c0 if the logic value of the selection signal sel is ‘0’. The second multiplexer MUX2 outputs the new coefficient c1 if the logic value of the selection signal sel is ‘1’. The third multiplexer MUX3 outputs the input signal x0 if the logic value of the selection signal sel is ‘0’. The third multiplexer MUX3 outputs the delayed signal x1 if the logic value of the selection signal sel is ‘1’.

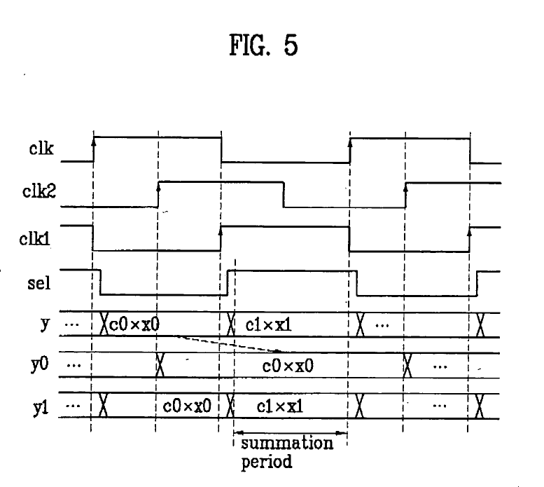

The second multiplier M12 receives the signals outputted from the second and third multiplexers MUX2 and MUX3 and multiplies the two received signals together. For instance, if the logic value of the selection signal sc1 is ‘0’, the second multiplier M12 multiplies the new coefficient c0 by the input signal x0. If the logic value of the selection signal sel is ‘1’, the second multiplier M12 multiplies the new coefficient c1 by the delayed signal x1. Hence, the second multiplier M12, as shown in FIG. 5, repeatedly outputs ‘c0×x0’ and ‘c1×x1’.

And, the seventh delayer D17 receives the signal ‘y’ outputted from the second multiplier M12 and outputs ‘c0×x0’ at a rising edge of the second clock signal clk2. The signal y0 outputted from the seventh delayer D17 keeps being outputted until a next rising edge of the second clock signal clk2.

Therefore, the LMS adaptive filter according to the present invention, as shown in FIG. 5, enables to simultaneously output the two signals ‘c0×x0’ and ‘c1×x1’ during a summation period of the reference clock signal.

Second Embodiment

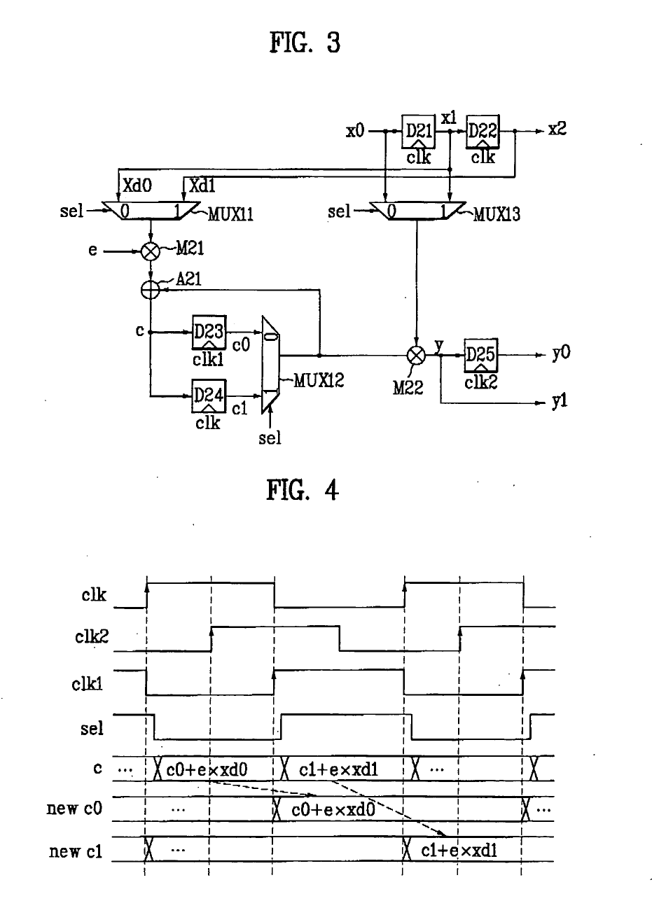

FIG. 3 is a block diagram of an LMS adaptive filter according to a second embodiment of the present invention.

Referring to FIG. 3, a first delayer D21 receives an input signal x0 and outputs a signal x1 delayed by a prescribed time behind the input signal x0. A second delayer D22 receives the delayed signal x1 and outputs a signal x2 delayed more than the delayed signal x1. The first and second delayers D11 and D12 are synchronized with a reference clock signal clk to output the delayed signals x1 and x2, respectively.

A first multiplexer MUX11 receives the two delayed signals xd0 and xd1. In this case, the delayed signals xd0 and xd1 are the signals x1 and x2 outputted from the first and second delayers D21 and D22, respectively. The first multiplexer MUX11 selectively outputs one of the delayed signals xd0 and xd1 according to a logic value or level of a selection signal sel inputted from outside.

A first multiplier M21 receives the signal outputted from the first multiplexer MUX11 and an error signal ‘e’ and then multiplies the two received signals together. An adder A21 adds a signal outputted from the first multiplier M11 to a previous coefficient outputted from a second multiplexer MUX12. A signal (coefficient) ‘c’ outputted from the adder A21 includes the delayed signals xd0 and xd1, the error signal ‘e’, and the previous coefficient.

A third delayer D23 stores the signal (coefficient) ‘c’ outputted from the first adder A21 and outputs a signal c0 delayed more than the signal ‘c’. The delayed signal c0 includes the delayed signal xd0, the error signal ‘c’, and the previous coefficient The third delayer D23 outputs the signal c0 by synchronization with a first clock signal clk1. In doing so, the first clock signal clk1 is delayed by ½ cycle more than the reference clock cycle clk Hence, if the reference clock signal clk indicates high level, the first clock signal clk1 becomes low level. If the reference clock signal clk indicates low level, the first clock signal clk1 becomes high level.

A fourth delayer D24 receives the signal ‘c’ outputted from the first adder A21 and outputs a signal c1 delayed more than the received signal ‘c’. The fourth delayer D24 outputs the delayed signal c1 by synchronization with the reference clock signal clk. The delayed signal c1 includes the delayed signal xd1, the error signal ‘e’, and the previous coefficient.

A second multiplexer MUX12 receives the two delayed signals c0 and c1, i.e., a pair of new coefficients, from the third and fourth delayers D23 and D24, respectively and then selectively outputs one of the delayed signals c0 and c1 according to a logic value or level of the selection signal sel.

A third multiplexer MUX13 receives the input signal x0 and the delayed signal x1 and then selectively outputs one of the signals x0 and x1 according to a logic value or level of the selection signal sel. For instance, if the selection signal sel indicates a low level, the third multiplexer MUX13 outputs the input signal x0. If the selection signal sel indicates a high level, the third multiplexer MUX3 outputs the delayed signal x1.

A second multiplier M22 receives signals outputted from the second and third multiplexers MUX12 and MUX13 and multiplies the two received signals together. A signal ‘y’ outputted from the second multiplier M22 includes the new coefficients c0 and c1, the input signal x0, and the delayed signal x1.

A fifth delayer D25 receives the signal ‘y’ outputted from the second multiplier M22 and outputs a signal y0 delayed more than the signal ‘y’ by synchronization with a second clock signal clk2. The second clock signal clk2 is a clock delayed by ¼ cycle more than the reference clock cycle clk.

Therefore, the LMS adaptive filter according to the present invention need not to be provided with the multipliers and adders as many as those of the related art filter, thereby decreasing in size 0.7 times less than that of the related art filter.

Accordingly, the present invention reduces the number of the multipliers and adders for the coefficient update, thereby enabling to decrease the filter size up to about 30%.

It will be apparent to those skilled in the art that various modifications and variations can be made in the present invention. Thus, it is intended that the present invention covers the modifications and variations of this invention provided they come within the scope of the appended claims and their equivalents.

1. An adaptive filter comprising:
a first multiplier alternately outputting a value calculated by multiplying a first delayed signal and an error signal together and a value calculated by multiplying a second delayed signal and the error signal together, wherein each of the first and second delayed signals is delayed behind an input signal;
an adder adding a signal outputted from the first multiplier to a previous coefficient;
a first delayer receiving a signal outputted from the adder and outputting a first new coefficient by synchronization with a first clock;
a second delayer receiving the signal outputted from the adder and outputting a second new coefficient by synchronization with a reference clock;
a second multiplier alternately outputting a value calculated by multiplying the first new coefficient and the input signal and a value calculated by multiplying the second new coefficient and a third delayed signal; and
a third delayer outputting a signal outputted from the second multiplier by synchronization with a second clock.

2. The adaptive filter of claim 1, wherein the first clock is delayed by ½ cycle more than the reference clock.

3. The adaptive filter of claim 1, wherein the second clock is delayed by ¼ cycle more than the reference clock.

4. The adaptive filter of claim 1, further comprising:
a first multiplexer outputting either the first delayed signal or the second delayed signal according to a selection signal;
a second multiplexer outputting either the first new coefficient or the second new coefficient according to the selection signal; and
a third multiplexer outputting either the input signal or the third delayed signal according to the selection signal.

5. The adaptive filter of claim 4, wherein the first multiplexer outputs the first delayed signal if a logic value of the selection signal is ‘0’ or the second delayed signal if the logic value of the selection signal is ‘1’.

6. The adaptive filter of claim 4, wherein the second multiplexer outputs the first new coefficient if a logic value of the selection signal is ‘0’ or the second new coefficient if the logic value of the selection signal is ‘1’.

7. The adaptive filter of claim 4, wherein the third multiplexer outputs the input signal if a logic value of the selection signal is ‘0’ or the third delayed signal if the logic value of the selection signal is ‘1’.

8. The adaptive filter of claim 1, wherein the first new coefficient includes the first delayed signal, the error signal, and the previous coefficient.

9. The adaptive filter of claim 1, wherein the second new coefficient includes the second delayed signal, the error signal, and the previous coefficient.

10. The adaptive filter of claim 1, wherein the third delayer outputs a signal including the first new coefficient and the input signal.

11. The adaptive filter of claim 1, further comprising a delayer receiving the first delayed signal to output the second delayed signal delayed behind the first delay signal.

12. The adaptive filter of claim 11, wherein the delayer synchronizes the second delayed signal with the reference clock to output.

13. The adaptive filter of claim 1, further comprising a delayer receiving the input signal to output the third delayed signal delayed behind the input signal.

14. The adaptive filter of claim 13, wherein the delayer synchronizes the third delayed signal with the reference clock to output.

15. The adaptive filter of claim 13, wherein the delayer provides the first delayed signal to the first multiplexer.

16. An adaptive filter comprising:
a first multiplexer outputting either a first delayed signal and a second delayed signal according to a selection signal, wherein each of the first and second delayed signals is delayed behind an input signal;
a first multiplier multiplying a signal outputted from the first multiplexer by an error signal;
an adder adding a signal outputted from the first multiplier to a previous coefficient;
a first delayer receiving a signal outputted from the adder to output a first new coefficient by synchronization with a first clock;
a second delayer receiving the signal outputted from the adder to output a second new coefficient by synchronization with a reference clock;
a second multiplexer outputting either the first new coefficient outputted from the first delayer or the second new coefficient outputted from the second delayer to the adder according to the selection signal;
a third multiplexer outputting either the input signal or a third delayed input signal delayed behind the input signal according to the selection signal;
a second multiplier multiplying the first or second new coefficient outputted from the second multiplexer by a signal outputted from the third multiplexer; and
a third delayer synchronizing a signal outputted from the second multiplier with a second clock to output.

17. The adaptive filter of claim 16, wherein the first multiplexer alternately outputs the first delayed input signal and the second delayed input signal.

18. The adaptive filter of claim 16, wherein the first new coefficient includes the first delayed input signal, the error signal, and the previous coefficient.

19. The adaptive filter of claim 16, wherein the second new coefficient includes the second delayed input signal, the error signal, and the previous coefficient.

20. The adaptive filter of claim 16, wherein the second multiplier alternately outputs a signal including the first new coefficient and the input signal and a signal including the second delayed input signal and the third delayed input signal.
